(19) United States
(12) Patent Application Publication
(10) Pub. No.: US 2017/0192744 A1
(43) Pub. Date: Jul. 6, 2017

(54) AUDIO RE-RECORDABLE FIRST-CLASS MAILER

(71) Applicant: Josh M. Wachsman, Wellington, FL (US)

(72) Inventor: Josh M. Wachsman, Wellington, FL (US)

(21) Appl. No.: 15/394,796

(22) Filed: Dec. 29, 2016

Related U.S. Application Data
(60) Provisional application No. 62/275,764, filed on Jan. 6, 2016.

(51) Int. Cl. G06F 3/16; H04R 1/02; B65D 27/00

(52) U.S. Cl. CPC G06F 3/165; B65D 27/00; H04R 1/028

(57) ABSTRACT

A re-recordable sound module to record and play unique voice and audio messages that is prepared and delivered as a US First-Class Mail Stamped Letter. More particularly, the re-recordable sound module is prepared and delivered within a two-way envelope as a US First-Class Mail Stamped Letter to foster two-way communication.

### CROSS-REFERENCE TO RELATED APPLICATION

The present application is a non-provisional application which claims priority to and the benefit of U.S. Provisional Application Ser. No. 62/275,764 filed on Jan. 6, 2016 and entitled “VoiceMailer, An Audio Recordable Device for Delivery Via First Class US Mail.”

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention relates to the field of audio communication by US First-Class Mail.

US Mail has delivered written communication for centuries. Technical advances and miniaturization of electronics and computers now allow lightweight hardware components for sound recording and listening to travel as a US First-Class Mail Stamped Letter. Personalized self-recorded messages can be mailed at a low cost. A two-way envelope (sometimes referred to as ‘hitchhiker’ envelope) provides two-way audio communication as a US First-Class Mail Stamped Letter. Previously, audio communication by mail may have been expensive or prohibited by postal or delivery restrictions. Low cost, easy to use audio recording enhances mailed communication and a two-way envelope completes the conversation.

### SUMMARY

A US First-Class Mail Stamped Letter that consists of a protected recording module inside a one-way or a two-way envelope that allows a unique, personalized audio message to be created by the user; it allows the message to be re-recorded if necessary; it is mailed as a US First-Class Stamped Letter; it is featured in a two-way envelope for reply communications; postage can be pre-affixed. The invention is particularly useful for locations that restrict telephone and internet devices, such as sleep-away camps for children, military installations, remote locations without electronic communications, and locations with such electronic restrictions. The invention is also useful for locations that allow stamped letters but restrict parcel and package deliveries. One-way and two-way personalized audio messages can also be used for invitations, replies, and thank-you notes; business promotion; novelty; and as an enhancement to all written communication. Audio First-Class Mail provides nuance to the sender's message and it may include sounds that cannot be communicated by the written word, e.g., singing, laughter, crying, pet sounds, music, etc.

### BRIEF DESCRIPTION OF THE SEVERAL VIEWS OF THE DRAWINGS

FIG. 1 is a schematic drawing of a re-recordable sound module placed within a protective card.

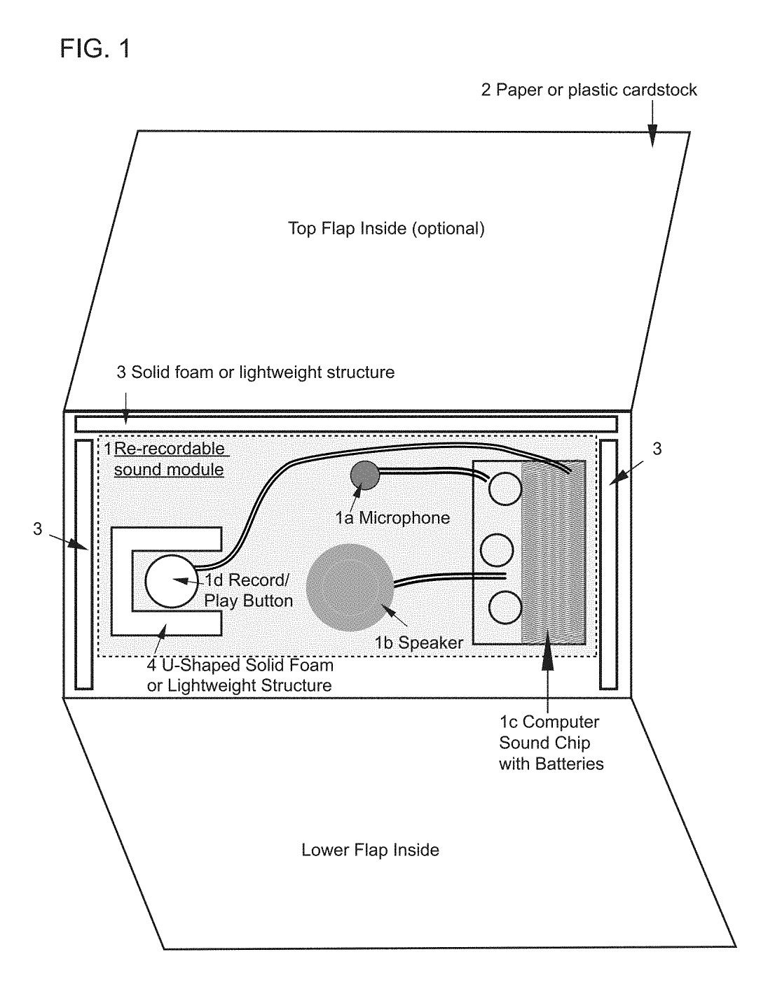

FIG. 2 is a view of the protective card in which the lower flap of the protective card is folded up to seal in the re-recordable sound module.

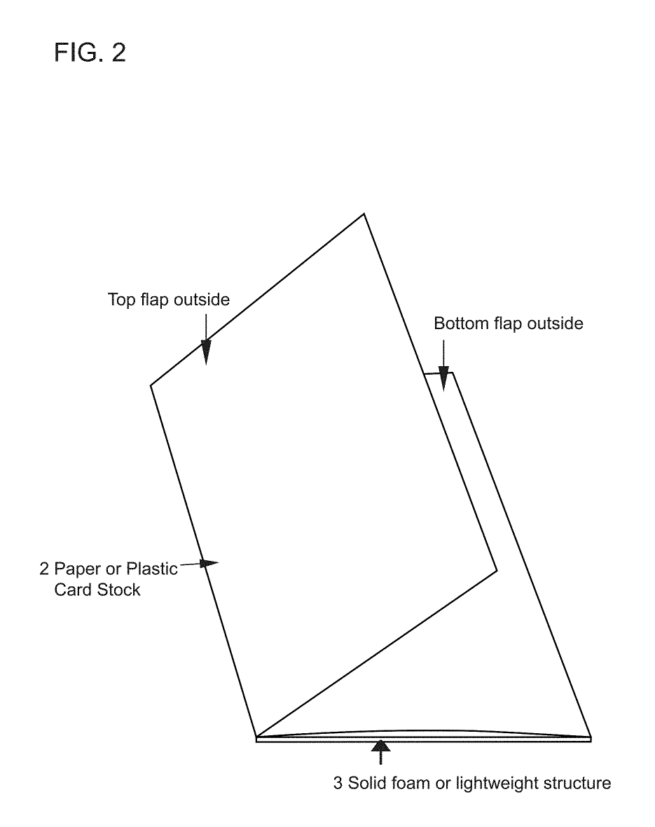

FIG. 3 is a schematic of a single envelope (Front and Back view) prepared for insertion of sound module with protective card.

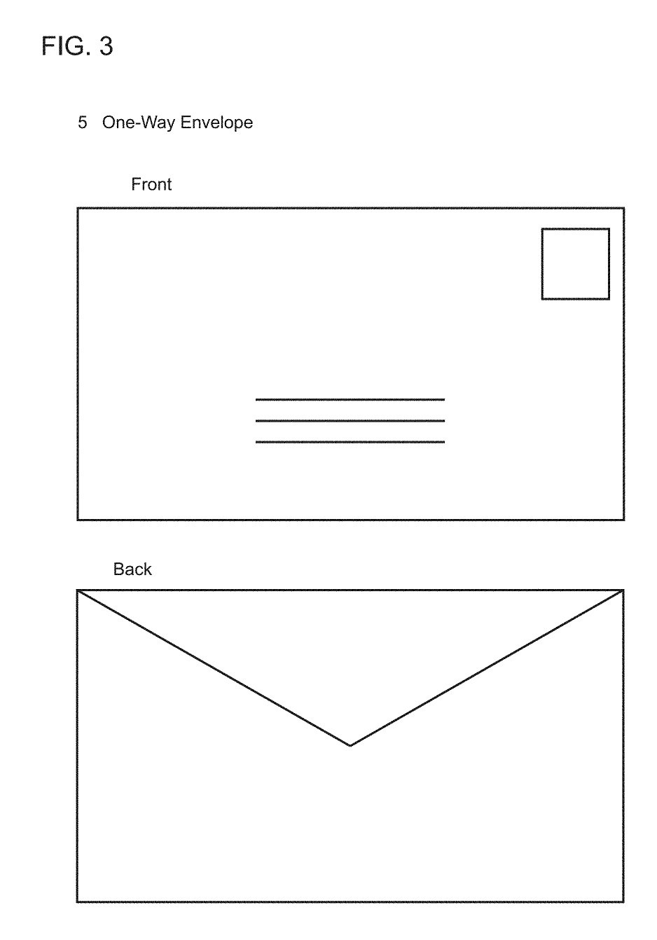

FIG. 4 is a schematic of a two-way envelope (Inside and Outside view) prepared for insertion of sound module with protective card.

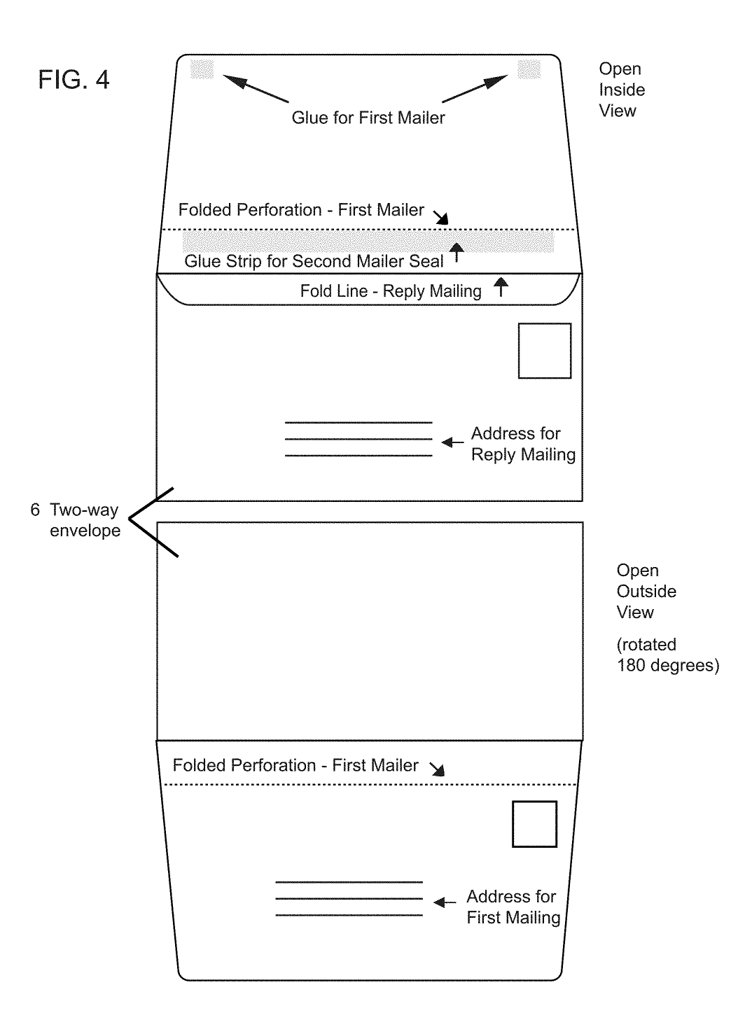

### DETAILED DESCRIPTION OF THE INVENTION

The Audio Re-Recordable First-Class Mailer includes a (1) re-recordable sound module that includes a (1a) microphone, (1b) speaker, (1c) computer sound chip with batteries, and a (1d) record/play button.

The Audio Re-Recordable First Class Mailer includes a (2) paper or plastic card stock to conceal and protect the sound module. The sound module is mounted upon the card stock and the card stock is folded over the sound module for protection and to obscure its view. The card stock may have one or more folds.

The Audio Re-Recordable First-Class Mailer includes (3) solid foam or other lightweight structures that are mounted at the edges of the card stock and a (4) U-shape solid foam or other lightweight structure that is mounted around the record/play button. The solid foam or other lightweight structures prevent damage to the sound module. The U-shape solid foam or other lightweight structure prevents accidental activation of the record/play button.

The Audio Re-Recordable First-Class Mailer includes a (5) one-way paper or plastic envelope for mailing a US First-Class Stamped Letter. In the case of a plastic envelope, it may be a clear envelope to reveal the paper or plastic card stock inside. The envelope may also be a (6) two-way envelope that promotes the re-use of the assembled sound module with card stock and foam or lightweight structure for two-way communications. The two-way envelope may be paper or a clear, plastic envelope.

The (1) re-recordable sound module and the (3) solid foam or other lightweight structures and the (4) U-shape solid foam or other light structure are mounted on the (2) card stock. The card stock is folded to seal inside itself the other components. The fully assembled card stock is used to record and play audio. The card stock is marked to indicate the location of the (1d) record/play button. Pressing and releasing the (1d) record/play button activates playing sound through the (1b) speaker. Pressing and holding the (1d) record/play button activates recording sound through the (1a) microphone. Sound is stored on the (1c) computer sound chip with batteries.

The fully assembled card stock can be placed in a (5) one-way paper or plastic envelope or a (6) two-way paper or plastic envelope. The (6) two-way envelope takes advantage of the re-recordability of the sound module and encourages the use of the fully assembled card stock for a reply and reduces the average cost of use.

The invention claimed is:

1. A US First-Class Mail Stamped Letter comprising: a re-recordable sound module consisting of a microphone, speaker, computer sound card with batteries, record/play button; protective card stock; additional lightweight foam or similar structure to protect the electronics; additional lightweight foam or similar structure to prevent activation of the record/play button, and a mailing envelope.

2. The invention in accordance with claim 1, wherein the mailing envelope is a two-way mailing envelope.
